(19) United States
(12) Patent Application Publication
(10) Pub. No.: US 2004/0160547 A1
(43) Pub. Date: Aug. 19, 2004

(54) LCD device having a reduced number of components

(75) Inventor: Hideaki Watanabe, Izumi-shi (JP)

Correspondence Address: YOUNG & THOMPSON, 745 SOUTH 23RD STREET 2ND FLOOR, ARLINGTON, VA, 22202

(73) Assignee: NEC LCD TECHNOLOGIES, LTD., KANAGAWA (JP)

(21) Appl. No.: 10/677,535

(22) Filed: Oct. 3, 2003

(30) Foreign Application Priority Data
Oct. 3, 2002 (JP) 2002/291199

(51) Int. Cl. G02F 1/1333

(52) U.S. Cl. 349/58

(57) ABSTRACT

A LCD device includes a housing including a front housing member and a rear housing member coupled by a coupling member, a panel unit mounted on the front housing member, a backlight having a plurality of optical components consecutively mounted on the panel unit. The coupling member is bent at a right angle for allowing the rear housing member to oppose the front housing member and to cover the lateral and rear sides of the panel unit and the backlight as a whole.

### BACKGROUND OF THE INVENTION

(a) Field of the Invention

The present invention relates to a liquid crystal display (LCD) device having a reduced number of components and, more particularly, to the improvement of a housing structure for receiving therein a LCD device including a panel unit and a backlight. The present invention also relates to a method for fabricating such a LCD device.

(b) Description of the Related Art

A LCD device roughly includes a panel unit including an LCD panel displaying thereon images and a driver IC for driving the LCD panel, a backlight unit for irradiating the LCD panel at the rear surface thereof, and a housing structure for receiving therein the panel unit and the backlight unit as a whole. The panel unit, and the backlight unit are arranged in this order as viewed from the front side toward the rear side of the LCD device, and form a LCD module in combination.

The LCD module may further include an interface IC for transferring therethrough data between the driver IC and a personal computer, for example, and a power circuit for supplying electric power to the lamp in the backlight unit, if the LCD device is used as a monitor for the personal computer. The term “LCD device” as used herein includes both the LCD module and the LCD monitor. Thus, in this text, a combination of a panel unit and a backlight unit received in a housing structure is referred to as LCD module (or LCD unit) whereas such a combination additionally including an interface IC and/or power circuit and used as a peripheral device for a personal computer etc. is referred to as monitor or LCD monitor, for distinguishing therebetween. A conventional LCD device will be described hereinafter with reference to an exemplified structure and a fabrication process thereof.

The backlight unit includes a lamp used as a light source, an electric circuit for energizing the lamp, and an optical system for converting the light emitted by the lamp into a parallel ray. The lamp and the optical system are assembled beforehand as a backlight unit, which is installed as a single fabrication element in the LCD module during fabrication thereof. The backlight unit has a planar shape of quadrangle, typically rectangle, and generally includes lens sheet, dispersion sheet, optical guide plate and reflection sheet, which are arranged in this order as viewed from the front side toward the rear side of the backlight unit. A pair of opposing edges of the optical guide plate are associated with respective lamps, each of which is covered by a reflector for reflecting the light emitted by the lamp to the internal of the optical guide plate through a corresponding edge thereof. The reflector and the reflection sheet in combination convert the light from the lamp into a parallel ray, which is directed to the rear surface of the LCD panel. The parallel ray is uniformised by the dispersion sheet and then condensed to the LCD panel by the lens sheet.

Fabrication of the backlight unit is performed by a process such as shown in FIGS. 11 to 14. In FIG. 11, a reflection sheet 31 is mounted on a rear frame 51, followed by mounting thereon a pair of reflectors 32 along the longer sides of the rear frame 51; The reflector 32 is of a rail-like shape, has a U-shape cross section, and receives therein an elongate lamp 33 attached thereto. It is to be noted that the rear frame 51 is disposed at the rear side of the LCD device in FIG. 11.

Subsequently, an optical guide plate 34, a dispersion sheet 35 and a lens sheet 36 are consecutively mounted on the reflection sheet 31, as shown in FIG. 12. The edge of the optical guide plate 34 is sandwiched between the two legs of the U-shaped reflector 32.

A front frame 52 is then mounted on the front side of the rear frame 51, and fixed thereto by screws 53, as shown in FIG. 13, to thereby obtain the backlight unit 37 shown in FIG. 14. It is to be noted that the top surface of the backlight unit 37 in FIG. 14 constitutes an irradiation surface of the backlight unit 37 opposing the rear surface of the LCD panel.

On the other hand, the panel unit is also obtained by combining the LCD panel and the driver IC as a unit. The panel unit, shown in FIG. 15, includes a LCD panel 39 and a plurality of driver ICs 13 mounted on respective flexible substrates 12 which are in turn mounted on the periphery of the LCD panel 39, a signaling board 15, and a pair of connection boards 14.

The LCD panel 39 has a well known structure wherein a pair of opposing glass substrates 10 and 11 sandwich therebetween a LC layer for encapsulation. One of the glass substrates, called array substrate 11, mounts thereon scanning lines, signal lines, pixel electrodes and thin film transistors (TFTs). The other of the glass substrates, called counter substrate 10, mounts thereon a counter electrode and color filters.

The array substrate 11 is somewhat larger than the counter substrate 10, and thus has a protruding edge at each of three sides thereof, the protruding edge protruding beyond the corresponding edge of the counter substrate 10. The flexible substrates 12 are arranged along the protruding edge of the array substrate 11, wherein one of the edges of each flexible substrate 12 is fixed onto the protruding edge of the array substrate 11. The other edge of each flexible substrate 12 is fixed onto the connection board 14 or signaling board 15. It is to be noted that the top surface of the panel unit 38 shown in FIG. 15 constitutes a display screen.

FIG. 16 shows the backlight unit 37, the panel unit 38 s and a front bezel 55 before fabrication thereof. The backlight unit 37 and the panel unit 38 are assembled to form a LCD module or LCD unit. More specifically, the panel unit 38 is mounted on the front surface of the backlight unit 37 to form a LCD module, followed by mounting thereon a front bezel 55. The front bezel 55 and the backlight unit 37 are coupled together by inserting hooks 56 formed on the lateral sides of the backlight unit 37 into respective hook holes 57 formed on the lateral sides of the front bezel 55.

FIG. 17 shows the LCD module before mounting thereon the front bezel 55. The panel unit 38 is mounted on the backlight unit 37 in alignment of the panel unit 38 with respect to a reference position, i.e., a projection formed on the irradiation surface of the backlight unit 37. After the mounting, the flexible substrates 12 attached onto the protruding edges of the panel unit 38 are bent toward the rear side of the backlight unit 37. Thereafter, the front bezel 55 is mounted on the front side of the panel unit 38, followed by inserting the hooks 56 formed on the lateral sides of the backlight unit 37 into the respective hook holes 57 formed on the lateral sides of the front bezel 55 to obtain the LCD unit 54 shown in FIG. 18.

For the above assembly process for the LCD unit 54, it is important to obtain an accurate alignment between the panel unit 38 and the front bezel 55. A variety of techniques for obtaining the accurate alignment are proposed heretofore. In the process as exemplified above, such an alignment is achieved by inserting the hooks 56 formed on the backlight unit 38 into the hook holes 57 formed in the front bezel 55.

Patent Publication JP-A-11-281963 describes one of the techniques for the alignment, which will be described with reference to FIG. 16 although FIG. 16 does not show the components described in the patent publication.

A pair of opposing bosses (not shown) are provided on a diagonal line of the top surface of the frame of the backlight unit 37, the bosses projecting toward the vicinities of edges of the panel unit 38. The front bezel 55 is provided with a V-shape thrust member (not shown) at the position corresponding to one of the pair of bosses, the thrust member projecting toward the backlight unit 37. The panel unit 38 is first mounted on the backlight unit 37, with the edges of the panel unit 38 being adjacent to the bosses disposed outside the panel unit 38. When the front bezel 55 is mounted on the panel unit 38 and screwed to the backlight unit 37, the V-shape thrust member is thrust into a gap between the one of the bosses of the backlight unit 37 and the edge of the panel unit 38 to urge the panel unit 38 to move horizontally toward the other of the bosses of the backlight unit 37, whereby the panel unit 38 is positioned with respect to the backlight unit 37 and the front bezel 55.

FIG. 19 shows the assembly of a LCD monitor, including the step of installing the LCD unit 54 shown in FIG. 18. A signal conversion board 16 and an inverter board 17 are attached onto the rear side of the LCD unit 54 with a rear metal plate 58 interposed therebetween. The signal conversion board 16 mounts thereon an interface IC which transfers signals between the driver IC in the LCD panel and a computer while converting the signals from the LCD unit and the computer to adapt the signals to the counterparts. The signal conversion board 16 transfers signals between the signaling board 15 shown in FIG. 15 and the computer. The inverter board 17 applies a specified voltage to the lamp in the backlight unit 37. These boards 16 and 17 are mounted on the LCD unit 54 to obtain a monitor body by screwing the boards 16 and 17 to the rear metal plate 58, which is in turn screwed to the rear side of the LCD unit 54.

FIG. 20 shows the resultant monitor body 59, which is then received in a housing to obtain a final monitor product. FIG. 21 shows the housing structure including a frame-like front housing member 19 and a planar rear housing member 18, which sandwich therebetween the monitor body 59. For the final assembly, the monitor body 59 is mounted onto the rear housing member 18, followed by covering the monitor body 59, at the front and lateral edges thereof, with the front housing member 19 having a L-shape cross section. The front housing member 19 and the rear housing member 18 are coupled together by screws after inserting the hooks formed on the inner surface of the front housing member 19 into the hook holes formed on the rear housing member 18.

The conventional LCD device as described above has the following profiles or features. First feature is such that the LCD device has the backlight unit 37 and the panel unit 38 formed as an integrated LCD unit. Second feature is such that the LCD unit includes a front bezel 55 as an essential component. Third feature is such that the LCD unit is assembled by mounting the panel unit 38 onto the backlight unit 37, and then covering the panel unit 38 with the front bezel 55 at the front and lateral sides of the panel unit 38. In the assembly process, no reference position is provided for the alignment either on the panel unit 38 or on the front bezel 55, wherein the panel unit 38 and the front bezel 55 are aligned with each other via the backlight unit 37. The second and third features are common to the LCD unit of FIG. 17 and to the LCD unit described in JP-A-11-281963.

Fourth feature is such that the housing is an essential component for assembling the LCD unit as a monitor, and that the housing includes the front housing member 18 and the rear housing member 19 which are coupled together after sandwiching therebetween the monitor body. Patent Publication JP-A-9-297542 describes a coupling structure between the front housing member 18 and the rear housing member 19, wherein both the front housing member 18 and the rear housing member 19 have engagement members for coupling therebetween.

The conventional LCD device has the following problems to be solved due to the four features described above.

First, the conventional LCD device has a large number of components and thus necessitates a large number of steps for fabrication thereof. More specifically, the backlight unit, for example, includes lamp, reflector, reflection sheet, optical guide plate, dispersion sheet, lens sheet etc., which are indispensable to the function of the LCD unit, as well as front frame 52 and rear frame 51 (refer to FIG. 13) which are additional components used for merely assembling the indispensable components.

In addition, for obtaining the unit structure for the LCD unit, the additional component, front bezel 55, is used for assembling the backlight unit 37 and the panel unit 38 which are inherently indispensable components (refer to FIG. 17).

In the assembly process for the backlight unit, the front frame 52 and the rear frame 51 provided separately are coupled together by using screws 53 etc, as shown in FIG. 13. The assembly process for the LCD unit includes the complicated steps of inserting the hooks 56 provided on the backlight unit 37 into the hook holes 57 formed on the front bezel 55, as shown in FIGS. 16 to 18, and fixing the front housing member 19 and the rear housing member 18 together by screws, as shown in FIG. 21.

The presence of the large number of components complicates the purchasing and storing management of the components, which may sometimes incur a delay of the delivery for the components, and prevents a stable production to raise the cost of the products.

Second, the alignment accuracy of the front bezel 55 with respect to the panel unit 38 (refer to FIGS. 16 to 18) in the LC unit 54 is not satisfactory. More specifically, it is difficult to align the opening of the front bezel 55 with the display area of the LCD panel. As described before in connection with the third feature of the LCD device, since there is no reference position provided on either of the panel unit 38 and the front bezel 55 for alignment therebetween, the panel unit 38 and the front bezel 55 are aligned via the backlight unit 37. This may cause a larger deviation between the panel unit 38 and the front bezel 55 because the deviation may be a sum of a deviation between the backlight unit 37 and the panel unit 38 and a deviation between the backlight unit 37 and the front bezel 55.

In view of the problems described heretofore, it is an object of the present invention to provide a LCD device having therein a reduced number of components.

It is another object of the present invention to provide a LCD device for which the components are assembled with ease.

It is another object of the present invention to provide a method for fabricating a LCD device, wherein the alignment accuracy between the display area of the LCD panel and the opening of the housing can be improved.

### SUMMARY OF THE INVENTION

The present invention provides a LCD device including: a panel unit including a LCD panel and a driver circuit for driving the LCD panel; a backlight including a plurality optical components consecutively mounted on the LCD panel; a housing for receiving therein the panel unit and the backlight, the housing including a front housing member formed as a frame and at least one rear housing member covering lateral and rear sides of the backlight and the panel unit as a whole, the front housing member and the rear housing member being coupled together via a coupling structure.

The present invention also provides a method for fabricating a liquid crystal display (LCD) device including the steps of: mounting a panel unit on a front housing member of a housing structure which includes the front housing member, a rear housing member and a coupling structure for coupling together the front housing member and the rear housing member; consecutively mounting a plurality of components of a backlight on a rear side of the panel unit, the backlight having a function for irradiating the panel unit with a parallel ray; moving the rear housing member with respect to the front housing member for allowing the rear housing member to cover lateral and rear sides of the backlight and the panel unit as a whole.

In accordance with the LCD device of the present invention and the LCD device fabricated by the method of the present invention, the number of components of the LCD device can be reduced to simplify the fabrication process thereof.

The above and other objects, features and advantages of the present invention will be more apparent from the following description, referring to the accompanying drawings.

### BRIEF DESCRIPTION OF THE DRAWINGS

FIGS. 1A and 1B are schematic sectional views of a LCD monitor according to a first embodiment of the present invention, in a closed state and an opened state, respectively, of the foldable housing.

FIG. 2 is an exploded perspective view of the LCD monitor of the first embodiment.

FIG. 3 is a perspective view of the front housing member used in the LCD monitor shown in FIG. 2.

FIG. 4 is a partial sectional view of the LCD monitor of FIG. 2, showing the detail of a panel unit retention rib.

FIG. 5 is another partial sectional view of the LCD monitor of FIG. 2, showing the detail of an optical guide plate retention rib.

FIG. 6 is another partial sectional view of the LCD monitor of FIG. 2, showing the detail of a reflector retention rib.

FIG. 7 is another partial sectional view of the LCD monitor of FIG. 2, showing the detail of a rear housing member retention rib.

FIG. 8 is a sectional view of the LCD monitor of FIG. 2.

FIG. 9 is a sectional view of a coupling member used in a LCD monitor according to a second embodiment of the present invention.

FIG. 10A is a sectional view of a coupling member used in a LCD monitor according to a third embodiment of the present invention, and FIG. 10B is a sectional view taken along line X-X in FIG. 10A.

FIG. 11 is a perspective view of a backlight unit used in a conventional LCD device during a fabrication step thereof.

FIG. 12 is a perspective view of the backlight unit of FIG. 11 in the step subsequent to the step of FIG. 11.

FIG. 13 is a perspective view of the backlight unit of FIG. 12 in the step subsequent thereto.

FIG. 14 is a perspective view of the final structure of the backlight unit shown in FIG. 13

FIG. 15 is a perspective view of a panel unit used in the conventional LCD device.

FIG. 16 is an exploded perspective view of a LCD unit during a fabrication step thereof.

FIG. 17 is a perspective view of the LCD unit of FIG. 16 for showing the order of the fabrication steps thereof.

FIG. 18 is a perspective view of the LCD unit of FIG. 16 in the final structure.

FIG. 19 is a perspective view of a LCD monitor during a fabrication step thereof.

FIG. 20 is a perspective view of the LCD monitor of FIG. 19 in the step subsequent to the step of FIG. 19.

FIG. 21 is an exploded perspective view of the LCD monitor of FIG. 19.

### PREFERRED EMBODIMENTS OF THE INVENTION

Now, the present invention is more specifically described with reference to accompanying drawings, wherein similar constituent elements are designated by similar reference numerals throughout the drawings.

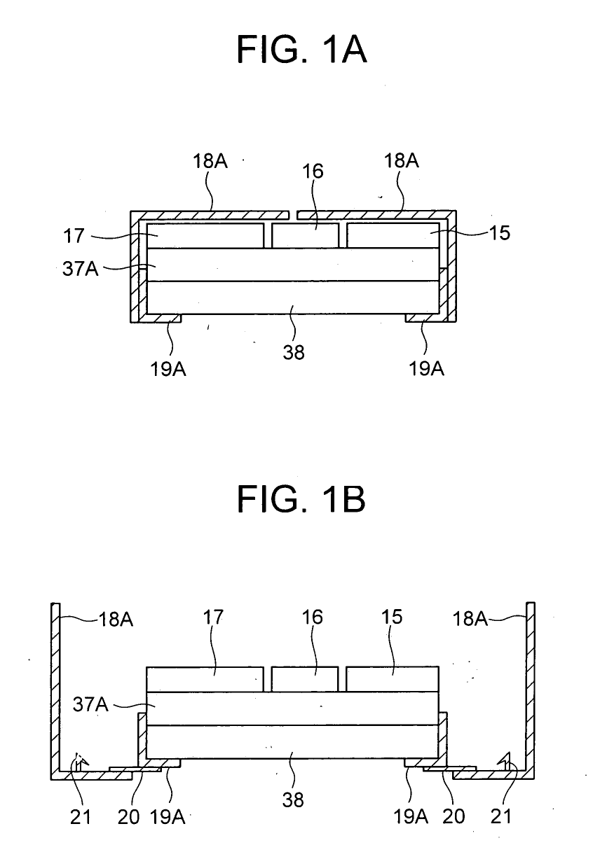

Referring to FIG. 1A, there is schematically shown a LCD monitor according to a first embodiment of the present invention. The LCD monitor includes a housing including a front housing member 19A and a pair of rear housing members 18A, and a LCD body received in the housing. The LCD body is referred to as LCD unit hereinafter, although the LCD body is in fact not formed as an assembled LCD unit, which can be installed as a unit element in the LCD device during the fabrication thereof. The rear housing members 18A cover the LCD unit at the rear and lateral sides of respective parts of the LCD unit. The front housing member 19A is formed as a frame having an L-shape cross section. The LCD unit includes a panel unit 38, a backlight 37A disposed at the rear side of the panel unit 38, and a group of circuit boards disposed at the rear side of the backlight 37A and including a signaling board 15, a signal conversion board 16 and an inverter board 17.

It is to be noted that the LCD unit shown in FIG. 1A has structures wherein the backlight 37A is not fabricated as a backlight unit, and the panel unit 38 and the backlight 37A are not formed literally as a LCD unit, wherein the front housing member 19A and the rear housing members 18A are coupled by coupling members to form a housing structure, and wherein the front housing member 19A has a projection or rib (not shown) for aligning the panel unit 38 with respect to the housing and a plurality of projections or ribs (not shown) for aligning the components of the backlight 37A with respect to the housing. The front housing member 19A and the rear housing members 18A are coupled by the coupling members to form a housing before receiving- therein the LCD unit including the components 38, 37A, 15, 16 and 17.

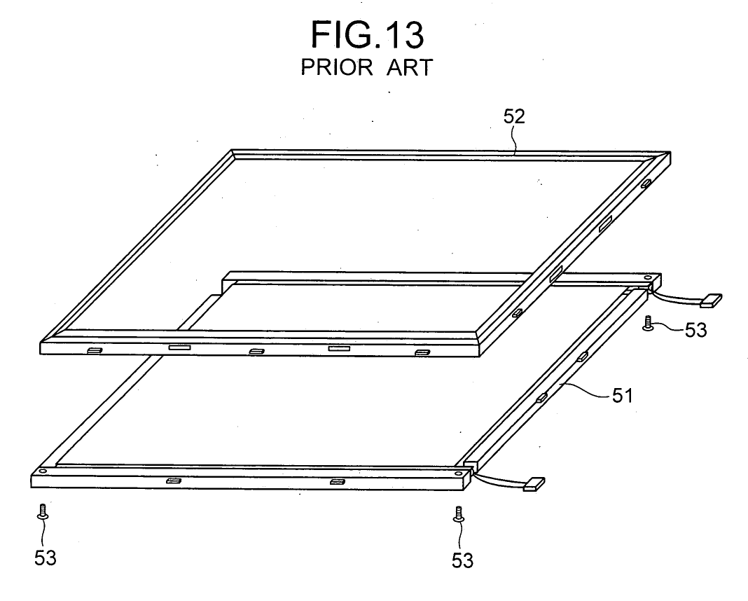

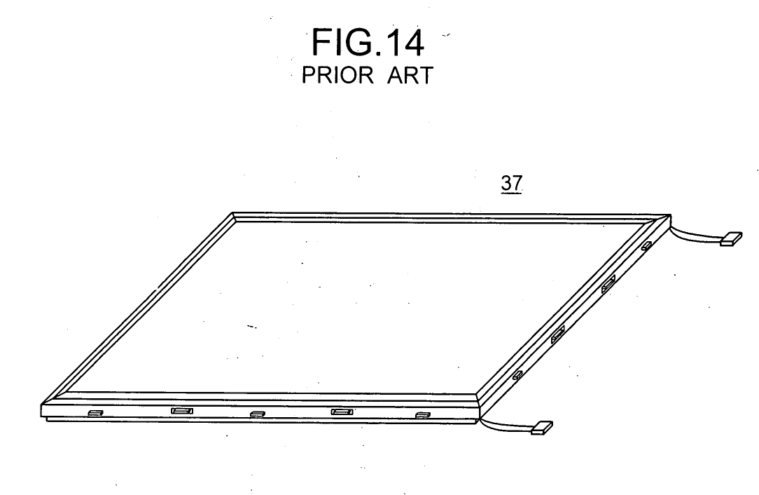

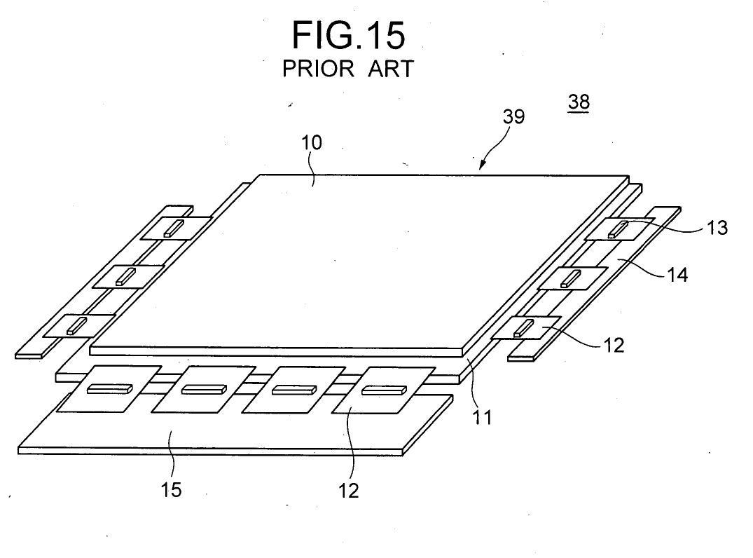

The panel unit 38 is similar to the panel unit shown in FIG. 15. The backlight 37A includes therein an optical system including lens sheet, dispersion sheet, optical guide plate, lamp, reflector and reflection sheet as well as an inverter board, similarly to the backlight unit 37 in the conventional LCD device. The backlight 37A includes, however, no front frame and rear frame, such as 52 and 51 shown in FIG. 13, because the backlight 37A is not formed as a unit.

Referring to FIG. 1B, there is shown the LCD device of FIG. 1A in the open state of the housing wherein the rear housing members 18A are disposed for exposing therefrom the LCD unit. For fabrication of the LCD device, the housing is first prepared by coupling the front housing member 19A and the rear housing members 18A together by the coupling members 20. Then, the panel unit 38, the components of the backlight 37A, and the group of circuit boards 15 to 17 are consecutively mounted on the inner surface of the front housing member 19A, with the rear housing members 18A being opened as shown in FIG. 1B. In this step, the panel unit 38 is positioned with respect to a projection, or rib, formed on the front housing member 19A. Similar ribs are provided on the front housing member 19A for respective components, such as the optical guide plate, reflector etc. of the backlight 17A.

After mounting the group of circuit boards 15, 16 17 on the backlight 37A, the rear housing members 18A are swiveled with respect to the front housing member 19A by bending the coupling members 20 to obtain the structure shown in FIG. 1A. Thus, the rear housing members 18A cover the LCD unit at the rear and lateral sides thereof. The coupling member 20 is made of soft plastics such as soft polyvinyl chloride for the feasibility of the bending. A hook rib 21 is formed on the inner surface of each rear housing member 18A whereas hook holes (not shown) are formed on the front housing member 19A at the positions corresponding to the hook ribs 21 for fixing the rear housing members 18A to the front housing member 19A. The coupling member 20 may be formed integrally with the front and rear housing members 19A and 18A instead as will be described later.

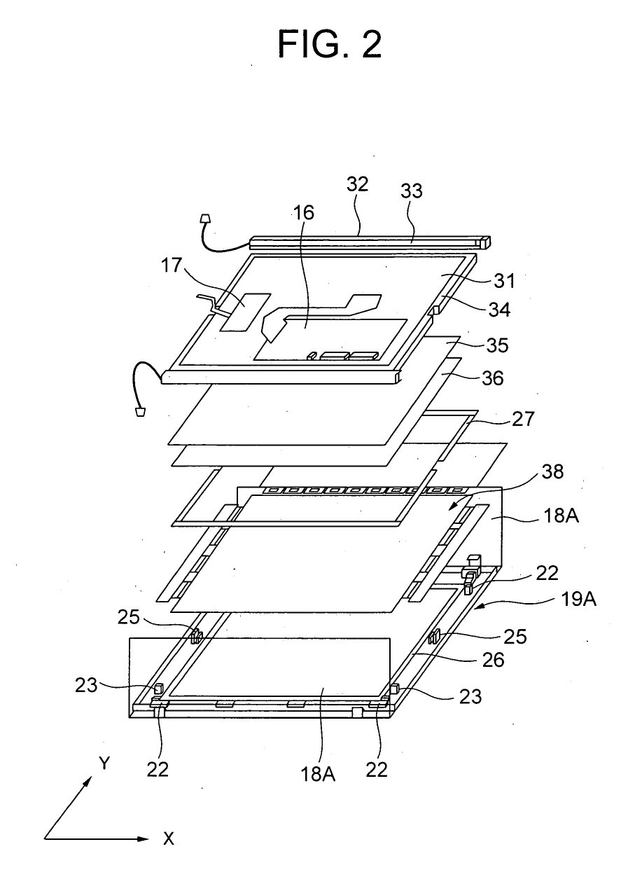

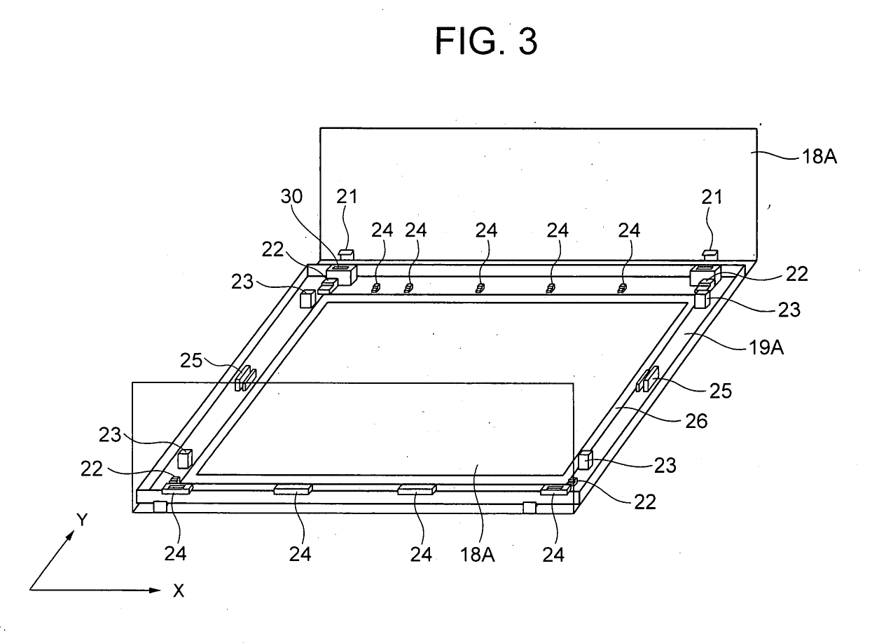

Referring to FIG. 2, there is shown the LCD monitor of the first embodiment in an exploded perspective view. It is to be noted that the front housing member 19A is shown at the bottom in FIG. 2. The structure of the front housing member 19A and the rear housing members 18 will be described with reference to FIG. 3. The opposing sides of the front housing member 19A of a frame shape are coupled to the rear housing members 18A each having an L-shape cross section by using coupling members 20 (FIG. 1B). The number of coupling members 20 for each rear housing member 18A may be two or more depending on the length of the rear housing member 18A. Alternatively, a single coupling member may be provided to extend along the whole length of the rear housing member 18A.

Each of the front and rear housing members 19A and 18A may be made of plastics such as polycarbonate having a thickness of about 2 mm. The L-shape cross section for the rear housing member 18A is formed by molding, wherein the widths of the flanges of the L-shape are selected depending on the shapes of the LCD unit received in the housing. The coupling member 20 has a thickness around 1/10 of the thickness of the front and rear housing members 19A and 18A for the feasibility of the bending. The front housing member 19A, rear housing members 18A and the coupling members 20 are assembled together by welding or bonding before fabrication of the LCD monitor.

The front housing member 19A has, on the inner surface thereof, panel unit retention rib 22, optical guide plate retention rib 23, reflector retention rib 24 and connection board retention rib 25. These ribs 22 to 25 are projections and function as references for the horizontal positions of the panel unit 38, optical guide plate, reflector and the connection board, respectively, which are consecutively mounted on the front housing member 19A. In particular, the panel unit retention rib 22 is provided at each corner of the front housing member 19A for positioning the panel unit 38 in both the X- and Y-directions.

Back to FIG. 2, on the front housing member 19A of the housing with the rear housing member 18A being opened, the panel unit 38 is first mounted, with the flexible substrates 12 being in an extended state as shown in FIG. 15. At this stage, the panel unit retention ribs 22 formed on the four corners of the front housing member 19A are used for positioning the panel unit 30 with respect to the front housing member 19A.

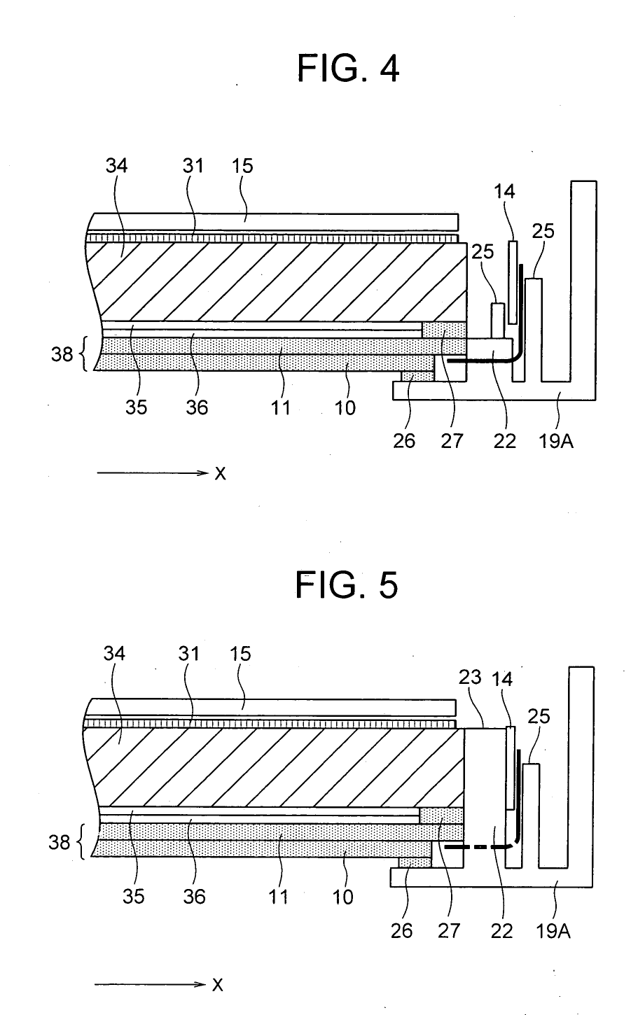

FIG. 4 shows the LCD monitor of the present embodiment after the backlight 37A is mounted on the panel unit 38, wherein there is shown the positioning of the panel unit 38, with an enlarged size of the panel unit retention rib 22. The panel unit 38 includes a pair of glass substrates including an array substrate 11 having a larger dimension than the other,. counter substrate 10. The edge of the array substrate 11 is positioned in contact with the panel unit retention rib 22 of the front housing member 19A. Such positioning is conducted in both the X- and Y- directions, whereby the display area of the LCD panel is accurately aligned with the opening of the front housing member 19A. It is to be noted that an elastic frame sheet 26 is interposed between the front housing member 19A and the panel unit 38 at the position inside the panel unit retention rib 22. The elastic frame sheet 26 absorbs the distortion of the front housing member 19A to improve the contact between the LCD panel and the front housing member 19A.

Back to FIG. 2, after mounting the panel unit 38 on the front housing member 19A, the components of the backlight 37A are consecutively mounted on the rear side of the panel unit 38. In this step, a frame spacer 27 is attached onto the outer periphery of rear side of the panel unit 38. The frame spacer 27 is made of plastics having a thickness of around 0.5 to 1.0 mm and a width of around 1.0 to 5.0 mm. The frame spacer 27 is adhered to the panel unit 38 by using an adhesive agent or adhesive tape attached to the frame spacer 27 beforehand. The lens sheet 36 and the dispersion sheet 35 constituting the backlight 37A are then mounted on the rear side of the panel unit 37 at the area within the frame spacer 27. Subsequently, the optical guide plate 34 is mounted on the frame spacer 27 whereby the thickness of the frame spacer 27 is equal to the space between the rear side of the panel unit 38 and the optical guide plate 34, and thus the lens sheet 36 and dispersion sheet 35 reside within the gap.

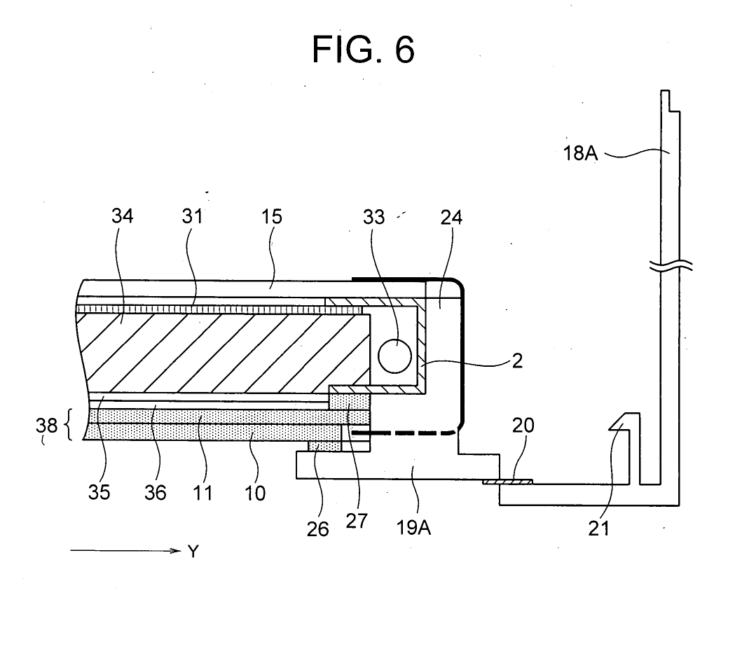

The optical guide plate 34 is attached with the reflector 32, which receives therein the lamp, at the edge of the optical guide plate 34 before mounting the optical guide plate 34 onto the rear side of the panel unit 38. The optical guide plate 34 thus mounted is in contact with the optical guide plate retention rib 23 in the X-direction, as shown in FIG. 5, whereas the reflector 32 thus attached with the optical guide plate 34 abuts against the reflector retention rib 24 in the Y-direction, as shown in FIG. 6, thereby aligning these components 34 and 32 with respect to the front housing member 19A. In an alternative configuration, the reflector 32 may be attached with the optical guide plate 34 after the optical guide plate 34 is mounted on the rear side of the backlight unit 38.

Back to FIG. 2 again, the reflection sheet 31 is then mounted on the rear side of the optical guide plate 34. At this step, the reflection surface of the reflection sheet 31 is in contact with the rear side of the optical guide plate 34. After mounting the reflection sheet 31, the flexible substrate 12 (shown in FIG. 15) connected to the signaling board 15 of the panel unit 38 is folded toward the backlight 37A, followed by folding the reflection sheet 31 toward the rear side to mount the signaling board 15 onto the rear side of the reflection sheet 31. Further, the flexible substrate 12 connected to the connection board 14 is bent at a right angle along the surface of the rear housing member 18A to locate the connection board 14 on the lateral side of the panel unit 38. The connection board 14 is fixed by the connection board retention rib 25 formed on the front housing member 19A (refer to FIG. 4). In an alternative configuration, the signaling board 15 and the connection board 14 may be mounted on the front housing member 19A, fixed onto the lateral side of the panel unit 38 or reflector 32, or extended toward the rear side of the reflection sheet 31 instead of the above configuration.

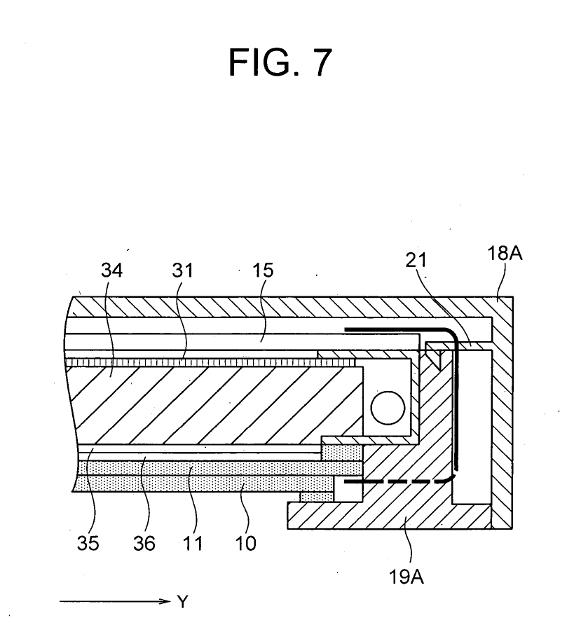

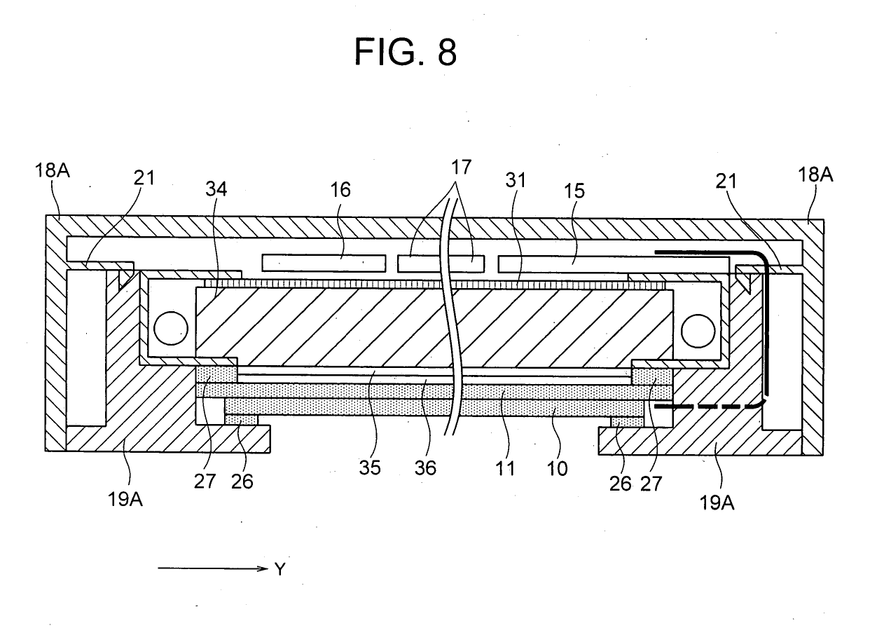

The signal conversion board 16 and the inverter board 17 are then mounted on a space of the rear side of the reflection sheet 31. Finally, as shown in FIG. 7, the connection member 20 of the housing is bent to locate the rear housing member 18A toward the rear side to close the housing. At this step, the rear housing retention rib 21 formed on the inner wall of the rear housing member 18A is elastically deformed to be inserted in the hook hold formed on the inner wall of the front housing member 19A for fixing the rear housing member 18A thereto, whereby the final structure of the LCD monitor shown in FIGS. 1 and 8 is obtained.

In the above embodiment, the backlight 37A is not formed as a unit and thus includes separate components including lens sheet 36, diffusion sheet 35, optical guide plate 34, dispersion sheet 33, and reflection sheet 31, which are consecutively mounted on the rear side of the panel unit 38 in the recited order during the fabrication of the LCD unit. This renders the front frame 52 and rear frame 51 shown in FIG. 13 to be unnecessary.

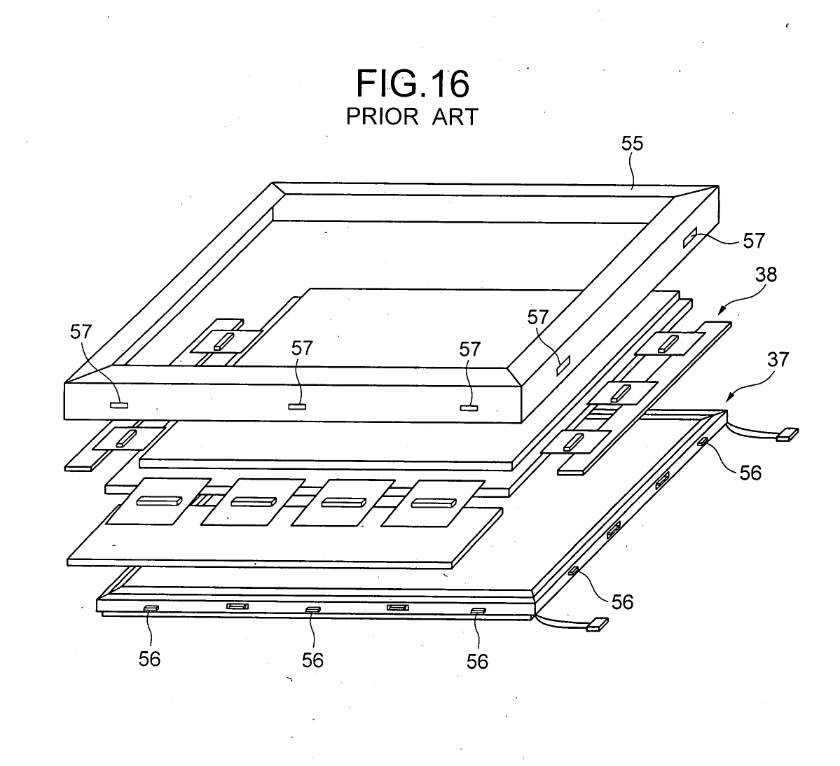

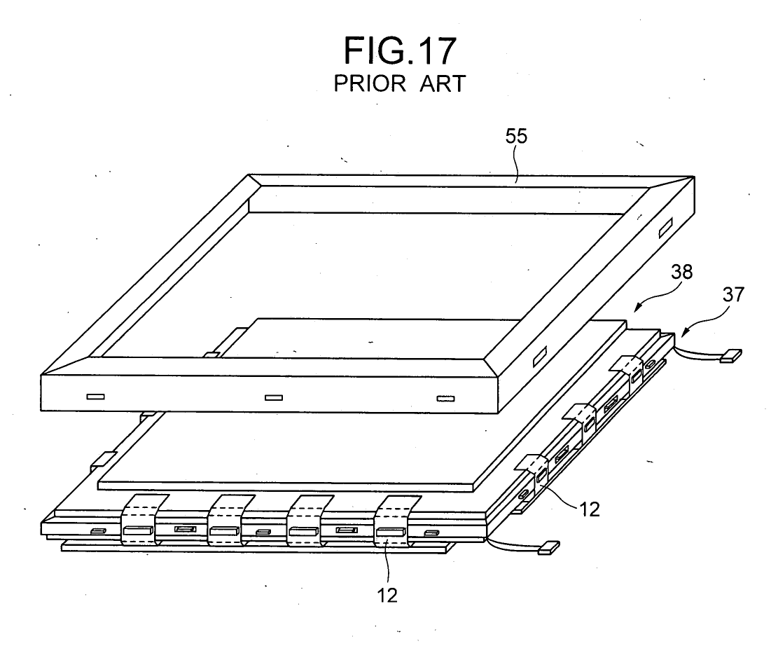

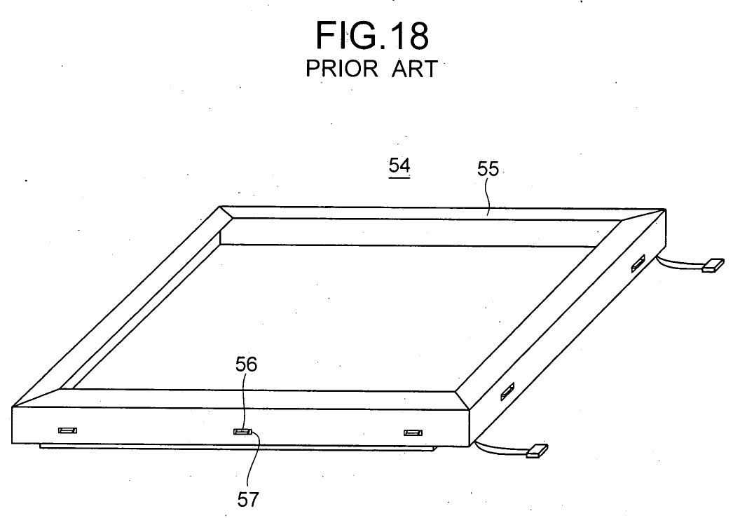

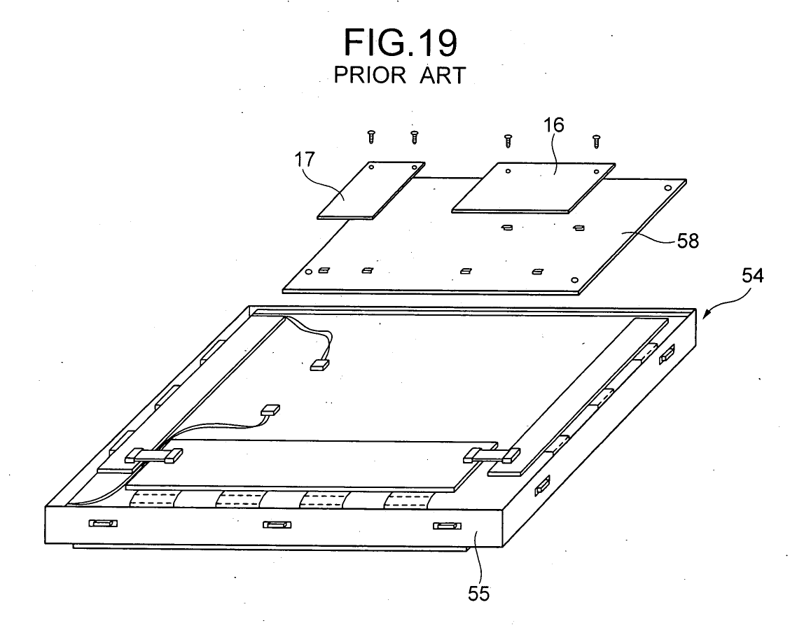

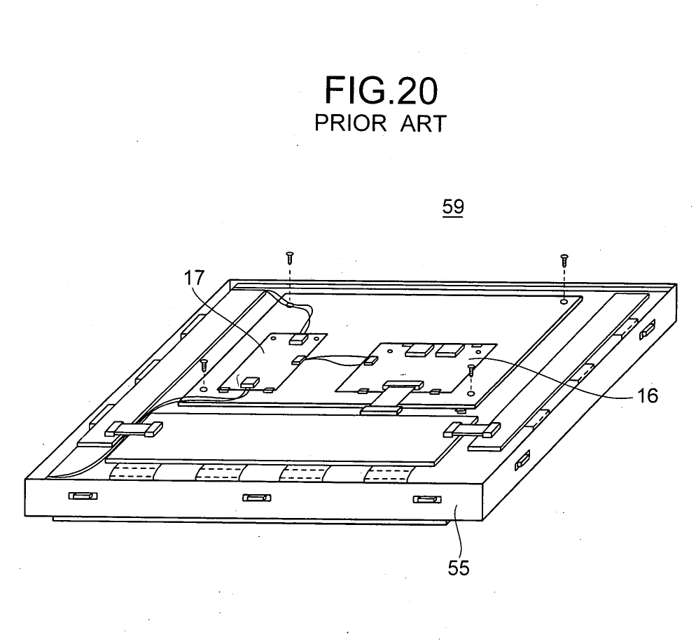

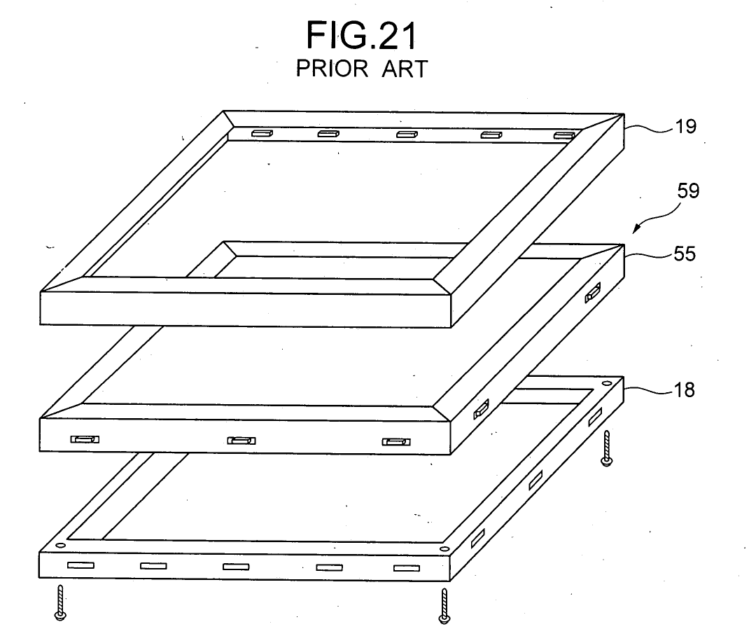

Since the panel unit 38 and the backlight 37A are not formed as a unit element, the front bezel 55 shown in FIGS. 16 and 17 is also unnecessary. The term “unit” as used herein means a composite device including a plurality of components, which can be installed as a single element in the LCD device during fabrication thereof.

In the present embodiment, since the backlight 37A is not formed as a unit, and the combination of the backlight 37A and the panel unit 38 is also not formed as a unit, the number of components used in the LCD monitor can be reduced.

In the LCD monitor of the present embodiment, the housing is formed as a single unit before mounting thereon the panel unit 38, backlight 37A etc., to thereby simplify the fabrication process. The structure of the housing includes the coupling member 20, which is finally bent for locating the rear housing member 18A toward the rear side of the front housing member 19A to form a housing unit. This also simplifies the fabrication process.

In the LCD monitor of the present embodiment, since the panel unit retention rib 22 formed on the front housing member 19A is used as a reference position of the panel unit 38 with respect to the front housing member 19A, the positional accuracy between the display area of the panel unit 38 and the opening of the front housing member 19A can be improved.

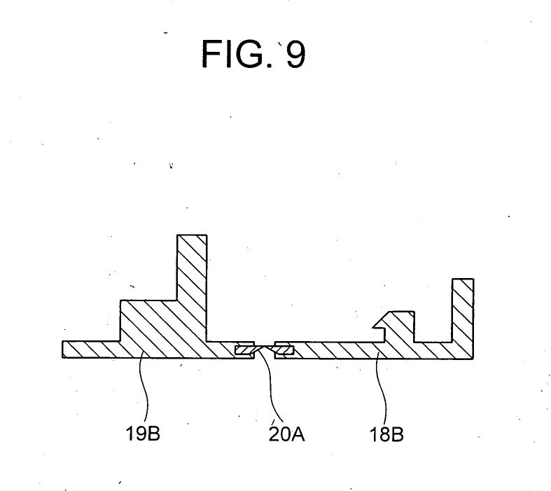

Referring to FIG. 9, there is shown a coupling member 20A used for coupling together the front housing member 19B and the rear housing member 18B in a LCD monitor according to a second embodiment of the present invention. The coupling member 20A in the present embodiment is formed as a substantially strip member having a central bending portion. Both edges of the coupling member 20A are inserted in the respective slots formed on the edges of the front and rear housing members 19B and 18B for fixing. The central bending portion may be replaced by a hinge, which may be fixed to the front and rear housing members 19B and 18B by welding, bonding, insertion or screws. The coupling member 20A may be made of plastics same as the material for the front and rear housing members 19B and 18B or may be made of a metal. This allows a larger design choice in the material for the coupling member.

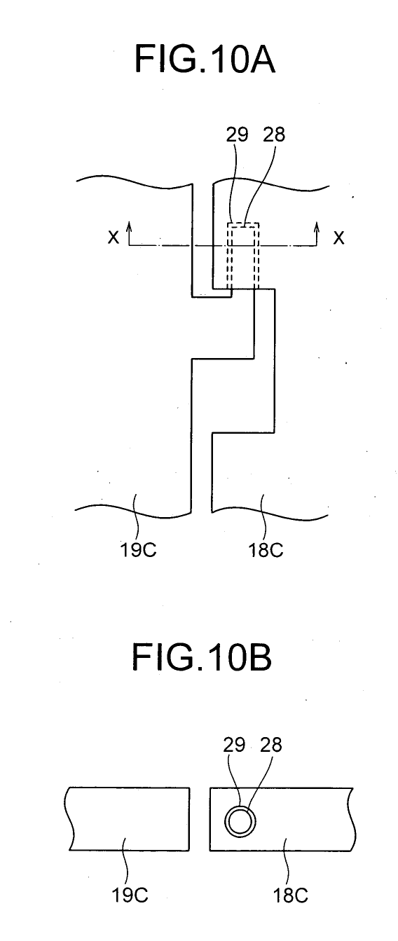

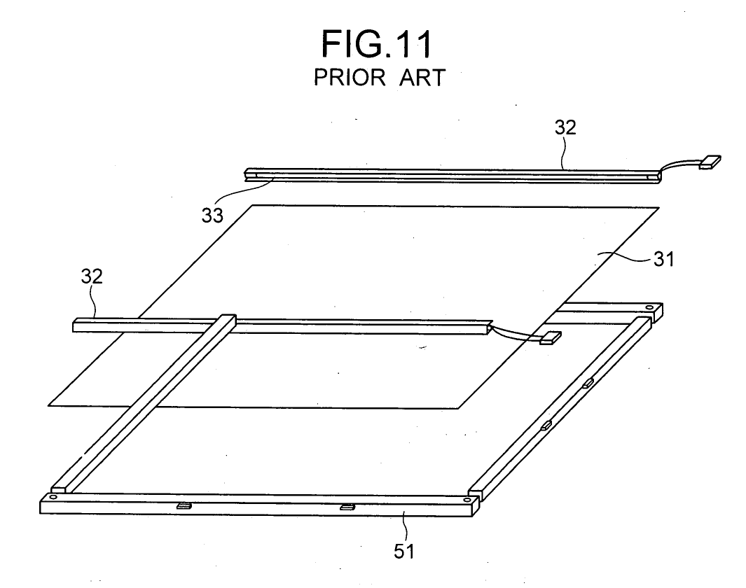

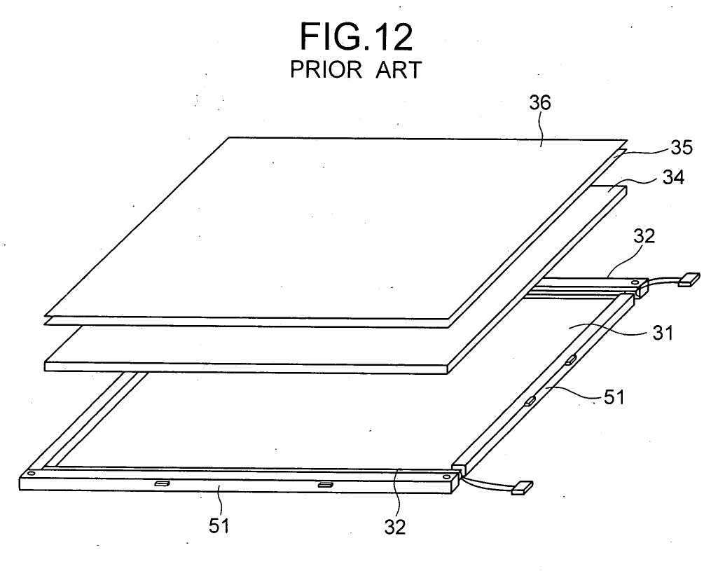

Referring to FIGS. 10A and 10B, there is shown a structure of the housing used in a LCD monitor according to a third embodiment of the present invention. The front housing member 19C in the present embodiment has a pivotal axis 28 adjacent to the rear housing member 18C, the pivotal axis 28 being received in a slot 29 formed on the edge of the rear housing member 18C. By pivoting the rear housing member 18C with respect to the pivotal axis 28 of the front housing member 19C, the rear housing member 18C can be closed with respect to the front housing member 19C.

In the first through third embodiments of the present invention, a pair of rear housing members are provided for a single front housing member. However, four rear housing members, for example, may be provided instead for respective sides of the rectangular front housing member.

In addition, the principle of the LCD monitor may be applied to a LCD module which includes no signal conversion board and no inverter board. The LCD module having such a structure obviates the provision of the front frame 52 and rear frame 51, simplifies the fabrication process and improves the positional accuracy between the panel unit 38 and the front housing member 19A, as well.

Since the above embodiments are described only for examples, the present invention is not limited to the above embodiments and various modifications or alterations can be easily made therefrom by those skilled in the art without departing from the scope of the present invention.

What is claimed is:

1. A liquid crystal display (LCD) device comprising:
a panel unit including a LCD panel and a driver circuit for driving said LCD panel;
a backlight including a plurality optical components consecutively mounted on said LCD panel;
a housing for receiving therein said panel unit and said backlight, said housing including a front housing member formed as a frame and at least one rear housing member covering lateral and rear sides of said backlight and said panel unit as a whole, said front housing member and said rear housing member being coupled together via a coupling structure.

2. The LCD device according to claim 1, wherein said backlight includes an interface IC for transferring signals and a power source circuit for supplying electric power to a lamp in said backlight.

3. The LCD device according to claim 1, wherein said panel unit and said backlight is consecutively mounted on said front housing member, and said rear housing member is swiveled with respect to said front housing member to cover said lateral and rear sides of said backlight and said panel unit.

4. The LCD device according to claim 3, wherein said at least one rear housing member include a plurality of rear housing members coupled to respective edges of said front housing members.

5. The LCD device according to claim 4, wherein said coupling structure includes a coupling member bent substantially at a right angle to allow a portion of said rear housing member to oppose said front housing member.

6. The LCD device according to claim 5, wherein said coupling member is formed as a separate piece attached to said front and rear housing members.

7. The LCD device according to claim 6, wherein said coupling member is made of soft plastics.

8. The LCD device according to claim 6, wherein said coupling member includes a hinge.

9. The LCD device according to claim 5, wherein said coupling member is attached onto said front and rear housing members by welding, bonding, insertion or screws.

10. The LCD device according to claim 5, wherein said coupling structure includes a pivotal axis and a slot formed on one and the other, respectively, of said front and rear housing members.

11. The LCD device according to claim 10, wherein said pivotal axis is formed as an integral part of said one of said front and rear housing members.

12. The LCD device according to claim 5, wherein said coupling structure further includes a hook and a hook hold engaged with said hook.

13. The LCD device according to claim 1, wherein said front housing member includes a first rib for aligning said panel unit with respect to said front housing member.

14. The LCD device according to claim 13, wherein said front housing member includes a plurality of second ribs for aligning said components of said backlight with respect to said front housing member.

15. A method for fabricating a liquid crystal display (LCD) device comprising the steps of:
mounting a panel unit on a front housing member of a housing structure which includes said front housing member, a rear housing member and a coupling structure for coupling together said front housing member and said rear housing member;
consecutively mounting a plurality of components of a backlight on a rear side of said panel unit, said backlight having a function for irradiating said panel unit with a parallel ray;
moving said rear housing member with respect to said front housing member for allowing said rear housing member to cover lateral and rear sides of said backlight and said panel unit as a whole.

16. The method according to claim 15, wherein said moving step includes swiveling said rear housing member with respect to said front housing member.

17. The method according to claim 16, wherein said coupling structure includes a coupling member, and said moving step includes bending said coupling member.

18. The method according to claim 15, wherein said coupling structure includes a pivotal axis and a slot for receiving said pivotal axis, and said moving step includes swiveling said rear housing member with respect to said front housing member.

19. The method according to claim 15, further comprising the step of mounting a circuit board on a rear side of said backlight before said moving step.
